(19) United States
(12) Patent Application Publication
(10) Pub. No.: US 2011/0122023 A1
(43) Pub. Date: May 26, 2011

(54) INERTIA/GNSS NAVIGATION SYSTEM

(76) Inventors: Jean-Claude GOUDON, Paris (FR); Simon Gavillet, Paris (FR)

(21) Appl. No.: 12/950,469

(22) Filed: Nov. 19, 2010

(30) Foreign Application Priority Data
Nov. 20, 2009 (FR) 0958238

(51) Int. Cl. G01S 19/26

(52) U.S. Cl. 342/357.65

(57) ABSTRACT

The invention relates to an inertia GNSS navigation System linked to a vehicle comprising:

a set of acquisition units of sensor data each delivering sensor data in digital form,

a unit for processing sensor data (30) configured to exploit digital data delivered by said set of acquisition units and to plot a status vector of the dynamics of the vehicle,

and in which the set of acquisition units of sensor data comprises:

a unit for acquiring and digitising GNSS signals (20) comprising an antenna structure (RA) configured to receive GNSS signals and an analog-digital converter (2) coupled to the antenna structure and configured to deliver GNSS signals in digital form to the unit for processing sensor data

an inertial measuring unit (6) configured to deliver inertial data originating from inertial sensors in digital form to the unit for processing sensor data.

### FIELD OF THE INVENTION

The field of the invention is that hybrid of navigation systems INS/GNSS (“Inertial Navigation System” and “Global Navigation Satellite System”) linked to vehicles, typically aeronautical carriers.

### BACKGROUND OF THE INVENTION

Civil air traffic is placing more and more restrictions on security and availability of navigation systems. GNSS systems, typically the GPS system (Global Positioning System), which become primary navigation means in more and more phases of flight, are still posing problems of vulnerability on interference and multi-path journeys.

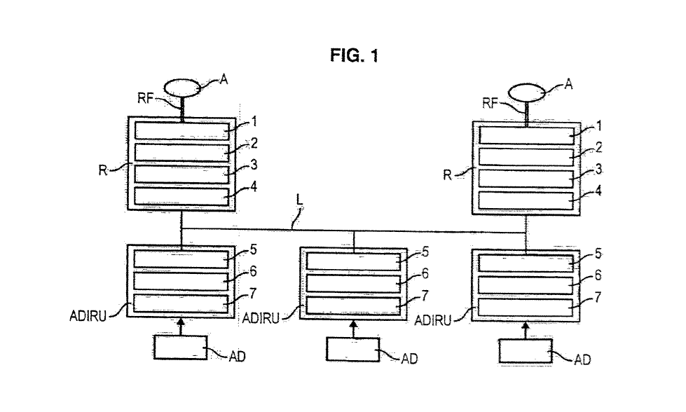

Architecture currently used in civil transport aircraft is represented in FIG. 1. This architecture is based on GNSS R receptors which each feed three ADIRU (Air Data Inertial Reference Unit) units operating redundantly in parallel to deliver a status vector of the dynamic of the aircraft.

Each of the GNSS R receptors is linked to a passive GNSS A antenna by means of an RF radiofrequency cable.

Each GNSS R receptor comprises a downconverter module 1 which lowers the frequency of the high-frequency analog GNSS signal delivered by the GNSS A antenna, an analog-digital conversion module 2 for digitising the GNSS signal, a processing module 3 configured to process the digitised GNSS signals and deliver GNSS positioning information of the aircraft, and an interface module 4 for addressing this positioning information via a digital link L to the various ADIRU units.

In addition to the GNSS positioning information delivered by the GNSS receptors, each ADIRU unit also receives data originating from aerodynamic data AD sensors (“air data” according to specialist terminology). These AD sensors, typically anemo-barometric sensors, generally measure information closest to the skin of the aircraft.

Each ADIRU unit comprises an interface module 5, inertial sensors 6 and a fusion module 7 of data originating from inertial sensors with the GNSS positioning information.

This architecture has the following disadvantages.

The RF cables necessary for conveying the analog signal picked up by a GNSS A antenna to a GNSS R receptor are often very long (ten metres typically) and are fairly heavy. A general attempt is made to reduce the mass of various equipment which is integrated into an aircraft.

This architecture is also not resistant to phenomena which conventionally disturb GNSS signals: intentional and non-intentional and multi-path interferences. To the extent where these phenomena can cancel out the capacity to pursue GNSS signals, the performance of the INS/GNSS navigation system can no longer be available, and the vehicle can then be obliged to abort or modify its mission.

Military carriers have responded to this problem by replacing passive antennae by a network of antennae of CRPA (Controlled Radiation Pattern Antenna) type whereof the signals are recombined inside dedicated equipment which makes spatial and temporal adaptation of the reception diagram of the network of antennae.

FIG. 2 illustrates a chain in which a network of RA antennae delivers GNSS analog signals by way of RF cables to such dedicated equipment E. This FIG. 2 uses the same reference numerals for elements identical to those already present in FIG. 1.

The dedicated equipment E comprises a frequency downconverter module 1, an analog-digital conversion module 2, a recombination module 8 of signals originating from different antennae, a digital-analog conversion module 9 and a frequency upconverter module 10.

This dedicated equipment E is linked by means of an RF cable to INS/GNSS NE navigation equipment fitted with inertial sensors 6, a frequency downconverter module 1 which lower's the frequency of the high-frequency recombined analog GNSS signal delivered by the dedicated equipment E, an analog-digital conversion module 2 for digitising the recombined GNSS signal, a processing module 3 configured to process the digitised recombined GNSS signal and deliver GNSS positioning information of the aircraft, as well as a fusion module 7 of data originating from inertial sensors with GNSS positioning information.

From one to three of these pieces of dedicated equipment E can be found on these military systems. Adding this type of equipment is costly in terms of mass. There is currently no equivalent product for civil aviation.

The document WO 2008/144 921 also discloses a GNNS antenna for converting GNNS signals in digital form for transmission to a GNNS receptor. This document also provides co-locating an inertial measuring unit with the antenna, this inertial measuring unit supplying inertial data to the antenna in analog form.

The aim of the invention is to improve the robustness of civil navigation systems to perturbations affecting GNSS signals, while avoiding any increase in mass.

### BRIEF DESCRIPTION OF THE INVENTION

To this effect, the invention proposes an inertia/GNSS navigation system linked to a vehicle, comprising:
a set of acquisition units of sensor data each delivering sensor data in digital form,
a unit for processing sensor data (30) configured to exploit digital data delivered by said set of acquisition units and to calculate a status vector of the dynamics of the vehicle,

and in which the set of acquisition units of sensor data comprises:
an acquisition and digitising unit of GNSS signals (20) comprising an (RA) antenna structure configured to receive GNSS signals and an analog-digital converter (2) coupled to the antenna structure and configured to deliver GNSS signals in digital form to the unit for processing sensor data
an inertial measuring unit (6) configured to deliver inertial data originating from inertial sensors in digital form to the unit for processing sensor data.

Certain preferred, though non-limiting, aspects of this system are the following:
the set of acquisition units of sensor data also comprises an acquisition and digitising unit for data originating from aerodynamic data sensors, the unit for processing sensor data also exploiting said aerodynamic data to calculate the status vector of the dynamics of the vehicle;
the inertial measuring unit is integrated within the unit for processing sensor data;
the inertial measuring unit is offset from the unit for processing sensor data;
the unit for processing sensor data is also configured to execute adaptive spatio-temporal or spatio-frequential processing of GNSS signals delivered by the acquisition and digitising module of GNSS signals;
the antenna structure is formed by a network of antennae with controllable radiation pattern, and the unit for processing sensor data is also configured to execute recombination of GNSS signals originating from each of the antennae of the network;
the unit for processing sensor data also utilises the inertial data output by the inertial measuring unit to determine the direction of satellites observable in the marker of the antenna structure, the gain of the antenna structure being modified in the determined directions;
the unit for processing sensor data corrects the GNSS signals delivered by the unit for acquiring and digitising GNSS signals on the basis of incoherence of the differences in phase and pseudo distance between each antenna of the network;
the unit for processing sensor data is also configured to execute at least hybridisation processing of data delivered by the various units of the set of acquisition units of sensor data to plot the status vector of the dynamics of the vehicle;
the system comprises a plurality of processing units of sensor data, and the unit for acquiring and digitising GNSS signals transmits the GNSS signals in digital form to several units of the plurality of units for processing sensor data;
the system comprises a plurality of units for processing sensor data, and the inertial measuring unit transmits inertial data in digital form to several units of the plurality of units for processing sensor data.

### BRIEF DESCRIPTION OF THE DIAGRAMS

Other aspects, aims and advantages of the present invention will emerge more clearly from the following detailed description of preferred embodiments thereof, given by way of non-limiting example and in reference to the attached diagrams, in which:

FIG. 1, already commented on, is a sketch illustrating the architecture of an INS/GNSS navigation system in current use in a civil aircraft;

FIG. 2, already commented on, is a sketch illustrating the architecture of a chain of an INS/GNSS navigation system used in a military aircraft;

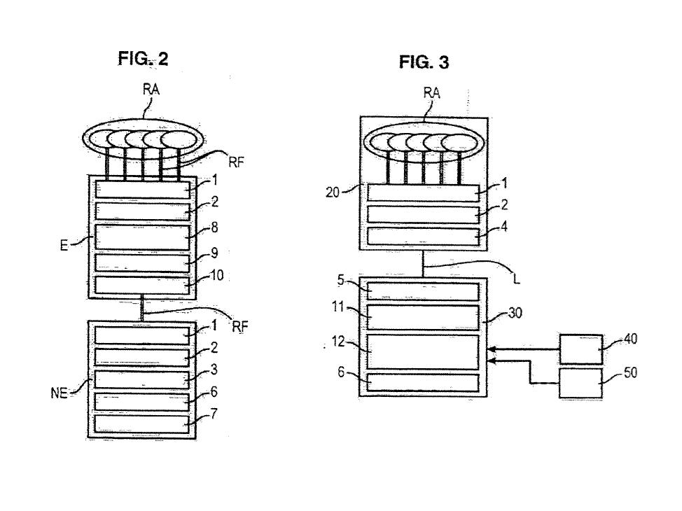

FIG. 3 is a sketch illustrating the architecture of a chain of an INS/GNSS navigation system according to a possible embodiment of the invention;

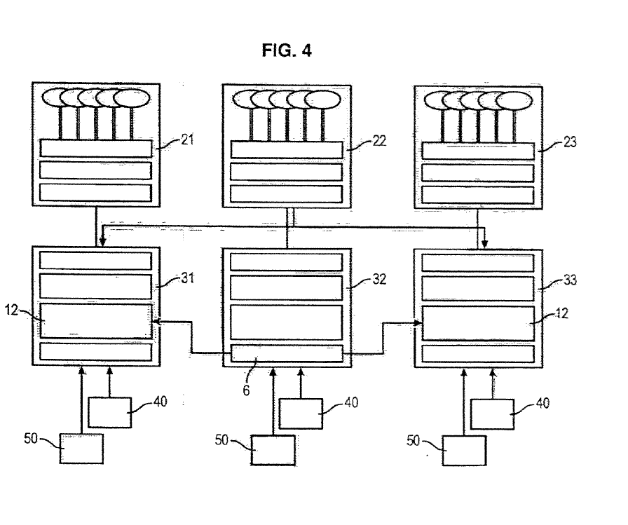

FIG. 4 is a sketch illustrating the information exchange between the various chains of an INS/GNSS navigation system according to a possible embodiment of the invention.

### DETAILED DESCRIPTION OF THE INVENTION

The invention proposes an inertia/GNSS navigation system linked to a vehicle, comprising a set of acquisition units of sensor data, said set comprising in particular a unit for acquiring and digitising GNSS signals comprising an antenna structure configured to receive GNSS signals and an analog-digital converter coupled to the antenna structure and configured to deliver GNSS signals in digital form.

The invention proposes replacing current antennae of radio navigation systems by an antenna structure, advantageously with controllable radiation pattern, linked to electronic RF elements for digitising the signal in the antenna structure and sending it to one or more sets of multifunctional equipment located elsewhere in the aircraft. Digitising of the received signal is integrated into the antenna structure, not the case in current CRPA antennae used especially in military aircraft, where such digitising takes place in the dedicated equipment E described earlier in relation to FIG. 2.

FIG. 3 illustrates a chain of an INS/GNSS navigation system according to a possible embodiment of the invention. This figure uses the same reference numerals for elements similar to those already present in FIGS. 1 and 2. It is also evident that in general three or four identical chains are required in an aircraft to ensure security and availability of the system in the event of breakdown.

As shown in this FIG. 3, the acquisition and digitising unit of GNSS signals 30 comprises an RA antenna structure configured to receive GNSS signals, a frequency downconverter module 1, an analog-digital converter 2 and an interface module 4 for addressing GNSS signals digitised via a digital link L to one or more units for processing sensor data 30.

In a preferred embodiment of the invention, the RA antenna structure is formed by a network of antennae with controllable radiation pattern.

It is evident that because of recent progress in terms of miniaturisation of analog-digital downconverter and converter modules, the acquisition and digitising unit 20 of GNSS signals has a footprint comparable to that of passive antennae in current usage.

The set of acquisition units of sensor data also comprises an inertial measuring unit 6 configured to deliver inertial data originating from inertial sensors in digital form.

This unit 6 typically comprises at least three gyrometers and three accelerometers. It can be integrated within the unit for processing sensor data 30, or else can constitute a distinct and less bulky unit, for example offset slightly from the centre of gravity of the vehicle.

The set of acquisition units of sensor data may also comprise an acquisition and digitising unit 40 of data originating from aerodynamic data sensors. This unit 40 is typically formed by anemo-barometric sensors which digitise information measured closest to the skin of the aircraft.

The unit for processing sensor data 30 exploits the digital data sent by said set of acquisition units and calculates a status vector of the dynamics of the vehicle (typically comprising the following information: 3D position, 3D speeds, attitude and cap angles, protection thresholds of these data).

The unit 30 comprises more precisely an interface module 5, a module 12 advantageously ensuring inside the same microprocessor recombination of GNSS signals originating from the different antennae of the network and the usual processing of an RF signal receptor, as well as a fusion module 12 of the different sensor data.

The fusion module 12 can especially be configured to execute adaptive spatio-temporal or spatio-frequential processing of GNSS signals delivered by the acquisition and digitising unit 30 of GNSS signals. Using this processing improves behaviour in interference, intentional or non-intentional, of the chain of radio-navigation and thus increases availability of precise and secure data of the status vector of the dynamics of the vehicle.

The fusion module 12 can also be configured to determine the direction of satellites observable in the marker of the antenna structure by exploiting the inertial data delivered by the inertial measuring unit 6. The gain of the antenna structure with controllable radiation pattern can then be modified in the determined directions, improving precision of data secured in the presence of multi-paths on radio frequency signals.

The fusion module 12 can also be configured to correct GNSS signals on the basis of incoherence of differences in phase and pseudo-distance between each antenna of the network. Such incoherence can be generated by reflections of signals on the external environment and the carrier and correction of GNSS signals then minimises the impact of multi-paths.

The fusion module 12 can also be configured to execute at least one hybridisation processing of data delivered by the different units of the set of acquisition units of sensor data to plot optimal and secure data of the status vector of the dynamics of the vehicle.

It is evident that in addition to sensors already described, the fusion module 12 can also be linked to an acquisition and digitising unit 50 of data originating from other external sensors such as radio-altimeter, radar-Doppler, optical sensors (IR, TV, . . . ), laser telemeter, etc.

Optimal data are obtained by the combination of the outputs of different digital filters (Kalman Filter, for example) exploiting measurements originating from various available sensors, including techniques in particular for detecting and excluding satellite breakdowns by using the redundancy of available measurements. Indicators of quality of data obtained (position, speed, attitudes) can also be plotted to ensure the level of an error with a given probability (notion of protective radius).

It will have been understood that the invention proposes carrying out all functions for processing data originating from various sensors (antenna structure, gyrometers, accelerometers, anemo-barometric sensors) as well as the fusion function of these data plotted inside the unit for processing sensor data.

Using the acquisition and digitising module of GNSS signals linked to adapted algorithms for processing signals executed inside the unit for processing sensor data enables a gain in terms of security (decrease from 20 to 30 dB of vulnerability to interference, reduction of vulnerability to multi-paths) and an evident gain in mass.

In addition, to the extent where data transmitted by the set of acquisition units of sensor data are digital, a unit for processing sensor data can receive data originating from one or more other chains to carry out surveillance functions and/or optimal multi-chain consolidation/reconfiguration functions improving the availability and security of the system.

This information exchange between three chains is shown in FIG. 4 in the form of solid lines. In this FIG. 4, the unit for acquiring and digitising GNSS signals 22 of the central chain transmits its digital data to three units for processing sensor data 31, 32, 33. The inertial measuring unit 6 of the central chain likewise transmits its digital data to the three units for processing sensor data.

As presented earlier, an inertial measuring unit 6 is not necessarily integrated within a unit for processing sensor data 31, 32, 33, but can constitute a distinct and less bulky unit, for example offset close to the centre of gravity of the vehicle. It is therefore feasible for one at least of the three inertial measuring units of FIG. 4 to constitute a distinct unit, offset from the units for processing sensor data, configured to deliver its inertial data to one or more of the units for processing sensor data 31, 32, 33.

1. An inertia/GNSS navigation system linked to a vehicle, comprising:
a set of acquisition unite of sensor data each delivering sensor data in digital form,
a unit for processing sensor data (30) configured to exploit digital data delivered by said set of acquisition units and to calculate a status vector of the dynamics of the vehicle, and in which the set of acquisition units of sensor data comprises:
a unit for acquiring and digitising GNSS signals (20) comprising an antenna structure (RA) configured to receive GNSS signals and an analog-digital converter (2) coupled to the antenna structure and configured to deliver GNSS signals in digital form to the unit for processing sensor data
an inertial measuring unit (6) configured to deliver inertial data originating from inertial sensors in digital form to the unit for processing sensor data.

2. The system as claimed in claim 1, in which the set of acquisition units of sensor data also comprises a unit for acquiring and digitising data originating from aerodynamic sensors of data (40), the unit for processing sensor data also exploiting said aerodynamic data to calculate the status vector of the dynamics of the vehicle.

3. The system as claimed in any one of claims 1 to 2, in which the inertial measuring unit is integrated within the unit for processing sensor data.

4. The system as claimed in any one of claims 1 to 2, in which the inertial measuring unit is offset from the unit for processing sensor data.

5. The system as claimed in any one of claims 1 to 4, in which the unit for processing sensor data is also configured to execute adaptive spatio-temporal or spatio-frequential processing of GNSS signals delivered by the acquisition and digitising module of GNSS signals.

6. The system as claimed in any one of claims 1 to 5, in which the antenna structure is formed by a network of antennae with controllable radiation pattern, and in which the unit, for processing sensor data is also configured to execute recombination of GNSS signals originating from each of the antennae of the network.

7. The system as claimed in claim 6, in which the unit for processing sensor data also uses inertial data delivered by the inertial measuring unit to determine the direction of satellites observable in the marker of the antenna structure and the gain of the antenna structure is modified in the determined directions.

8. The system as claimed in any one of claim 6 or 7, in which the unit for processing sensor data corrects GNSS signals delivered by the acquisition and digitising unit of GNSS signals on the basis of incoherence of differences in phase and pseudo-distance between each antenna of the network.

9. The system as claimed in any one of claims 1 to 8, in which the unit for processing sensor data is also configured to execute at least hybridisation processing of data delivered by the various units of the set of acquisition units of sensor data to plot the status vector of the dynamics of the vehicle.

10. The system as claimed in any one of claims 1 to 9, comprising a plurality of units for processing sensor data, and in which the acquisition and digitising unit of GNSS signals transmits GNSS signals in digital form to several units of the plurality of units for processing sensor data.

11. The system as claimed in any one of claims 1 to 10, comprising a plurality of units for processing sensor data, and in which the inertial measuring unit transmits inertial data in digital form to several units of the plurality of units for processing sensor data.
